(19) United States
(12) Patent Application Publication
(10) Pub. No.: US 2024/0157854 A1
(43) Pub. Date: May 16, 2024

(54) Child Occupancy Detection System and Method of Use

(71) Applicant: Cindy Lopez, Weslaco, TX (US)

(72) Inventor: Cindy Lopez, Weslaco, TX (US)

(21) Appl. No.: 18/508,545

(22) Filed: Nov. 14, 2023

Related U.S. Application Data
(60) Provisional application No. 63/425,370, filed on Nov. 15, 2022.

(51) Int. Cl. B60N 2/00

(52) U.S. Cl. CPC B60N 2/0025; B60N 2/003; B60N 2/0035

(57) ABSTRACT

A rear occupancy safety system for vehicles for detecting a child in a backseat or in a child seat. The system comprises one or more weight sensors integrated into the base of the backseat and into the base of the driver seat, a central controller, a user device with a preinstalled rear occupancy safety application, and a cloud server for storing emergency contact information. The weight sensors detect weight and a user is alerted on the application if weight is detected on the backseat but not on the driver seat for a predetermined time period. In cases when the weight is detected on the backseat but not on the driver seat exceeds the predetermined time period, then emergency contacts are alerted. The system can be integrated into the vehicle during manufacturing or retrofitted as an aftermarket system, improving the safety of passengers, especially children, in the backseat of vehicles.

### CROSS-REFERENCE TO RELATED APPLICATION

The present application claims priority to, and the benefit of, U.S. Provisional Application No. 63/425,370, which was filed on Nov. 15, 2022, and is incorporated herein by reference in its entirety.

### FIELD OF THE INVENTION

The present invention relates generally to the field of system and method of detecting children in a backseat or child seat of a vehicle. More specifically, the present invention relates to a novel system for detecting weight on a backseat or a child seat, and also on a driver seat of a vehicle to detect child occupancy on the backseat and alerting a driver, parent, or more when weight is detected on the backseat or the child seat for a predetermined period but not detected on the driver seat. The system prevents children from being left unattended in a vehicle, reducing the risk of injuries or fatalities. Accordingly, the present disclosure makes specific reference thereto. Nonetheless, it is to be appreciated that aspects of the present invention are also equally applicable to other like applications, devices, and methods of manufacture.

### BACKGROUND

By way of background, leaving a child unattended in a vehicle is common for even attentive parents and caregivers. Leaving a child or even an elderly person can have serious and even fatal consequences. It is common for parents and caregivers to become distracted or forget that children are in the backseat of a vehicle, especially if the child falls asleep or is otherwise quiet or the parent is talking to someone on a phone or listening to music. The risk is particularly high during hot weather conditions as temperatures inside the car can rise quickly, leading to heatstroke, dehydration, and other detrimental health conditions.

In many cases, parents or caregivers only realize that they have left their child in the car after it is too late. In many scenarios, it may be impossible to save the child's life. Despite the severity of the issue, many children safety systems are built but parents and caregivers are not notified automatically if a child is left in the vehicle. Further, a lot of false positives are created in the existing system that decrease the reliability and efficacy of such systems. In light of these concerns, there is a need for a reliable and efficient system that can alert parents and caregivers if they accidentally leave a child in the backseat of a vehicle.

Therefore, there exists a long felt need in the art for an alert system that detects if a child is present in the backseat of the vehicle. There is also a long felt need in the art for an alert system that notifies a parent, driver, or caretaker when a child is present in the backseat but no one is present in the driver seat. Additionally, there is a long felt need in the art for a child safety system that prevents children from being left unattended in a vehicle, reducing the risk of injuries or fatalities. Moreover, there is a long felt need in the art for a safety system that works based upon detecting weight on the driver seat and the backseat for detecting an occupancy on the backseat. Further, there is a long felt need in the art for a system that provides a notification in a user device of a user upon detection of a child in the backseat. Finally, there is a long felt need in the art for a safety and alert system that offers parents, grandparents, and caregivers a quick and effective reminder that a child is still inside the vehicle when they are not present in the vehicle.

The subject matter disclosed and claimed herein, in one embodiment thereof, comprises a rear occupancy safety system for vehicles. The system comprising at least one weight or pressure sensor integrated into the base of a backseat or child seat for detecting weight thereon and another weight or pressure sensor integrated into the base of a driver seat for detecting weight thereon, a central controller coupled to the weight sensors to receive and process sensor information, a user device with a preinstalled rear occupancy safety application, the application is configured to receive notifications from the central controller when weight is detected on the back seat or child seat sensor and not on the driver seat sensor for a predetermined time period, and a cloud server for storing emergency contact information, wherein the emergency contact information are retrieved in case of an emergency when weight is detected on the backseat for a higher threshold time while not detected simultaneously on the driver seat.

In this manner, the rear occupancy safety system of the present invention accomplishes all of the forgoing objectives and provides users with an alert system designed to notify a driver, parent, caretaker and the like when backseat weight is detected while driver weight is not detected for a predetermined period of time. The system pairs with a smartphone application for providing an alert if there is no weight detected in the driver's seat, but weight is detected in the child's seat.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a rear occupancy safety system for vehicles. The system includes a first weight sensor disposed in a backseat for detecting weight in the backseat or child seat, a second weight sensor disposed in a driver seat for detecting weight in the driver seat, the detected weight by the sensors is used for detecting presence of one or more occupants in the backseat. The system further alerts a driver or caretaker if weight is detected on the backseat but not on the driver seat for a predetermined time period. The system includes a central controller for receiving weight information from the sensors and generating an alert. The system can be integrated into the vehicle during manufacturing or retrofitted as an aftermarket system.

In another aspect of the present invention, a rear occupancy safety system for vehicles is disclosed. The system comprising at least one weight sensor integrated into the base of a backseat/child seat and another weight sensor integrated into the base of a driver seat for detecting weight, a central controller coupled to the weight sensors to receive and process sensor information, a user device with a preinstalled rear occupancy safety application, the application is configured to receive notifications from the central controller when weight is detected on the backseat sensor and not on the driver seat sensor for a predetermined time period, and a cloud server for storing emergency contact information, wherein the emergency contact information are retrieved in case of an emergency when weight is detected on the backseat for a higher threshold time while not detected simultaneously on the driver seat.

In yet another embodiment, the weight sensor used in the system includes a load cell configured to convert weight into an electrical signal by changing the electrical resistance thereof when weight is applied to the weight sensor, an amplifier for amplifying the electrical output signal of the load cell; an internal memory for storing configuration settings, including a threshold weight, a communication interface for establishing a wireless connection, and a processor for controlling the operation of the weight sensor, processing the output from the amplifier, and eliminating false positives.

In yet another embodiment, a method for providing notifications to a user regarding occupancy of a child on backseat/child seat of a vehicle is described. The method comprising the steps of installing a software application in a user device of a driver of a vehicle, pairing the application with a central controller disposed in the vehicle using a wireless channel established by the central controller, configuring the application with details of weight sensors disposed in the vehicle, including a minimum weight to be detected by the sensors and a time duration for generating notifications or alerts, and receiving real-time notifications by the configured application, wherein the notifications provide a reminder to the user that a child is inside the vehicle.

In yet another embodiment, a method for monitoring weight on a backseat of a vehicle is described. The method comprising the steps of activating a child safety alert beacon system to monitor the weight on the backseat and the driver seat of the vehicle, continuously monitoring the weight on the backseat and the driver seat using the backseat sensor and the driver seat sensor, respectively, determining if the backseat weight exceeds a predetermined threshold weight and if the driver seat weight is zero, transmitting an electric signal to a central controller if both conditions are met, activating a timer by the central controller, waiting by the controller for a predetermined amount of time to elapse, determining if the predetermined time has elapsed and if the backseat weight is still above the threshold weight and if the driver seat weight is still zero, generating an alert by the central controller if the conditions are met, to notify the driver or other user in the vehicle, wherein the alert is in the form of an audible alarm, visual display or other suitable means.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of a vehicle equipped with a rear occupancy safety system of the present invention in accordance with the disclosed architecture;

FIG. 2 illustrates a schematic view of the rear occupancy safety system showing the weight sensors and the supporting software application in accordance with the disclosed architecture;

FIG. 3A illustrates a block diagram depicting essential structural components or modules disposed in a weight sensor used in the safety system of the present invention in accordance with the disclosed architecture;

FIG. 3B illustrates essential components of the central controller for facilitating determination and transmission of alert for safety in accordance with the disclosed architecture;

FIG. 4 illustrates a process of pairing the weight sensors used in the safety system of the present invention with a user device having an installed application in accordance with the disclosed architecture;

FIG. 5 illustrates a flow diagram depicting a process of generating an alert for indicating a child left on a backseat of a vehicle by the child safety alert beacon system of the present invention in accordance with the disclosed architecture;

FIG. 6 illustrates a flow diagram depicting a process of configuring the backseat sensor of the child safety system of the present invention using the software application in accordance with the disclosed architecture;

FIG. 7 illustrates a flow chart depicting a process of alerting emergency contacts when the backseat sensor continues to detect weight while driver seat sensor detects zero weight in accordance with the disclosed architecture; and

FIG. 8 illustrates adhesive layer and enclosure of a sensor used in child safety and alert system of the present invention in accordance with the disclosed architecture.

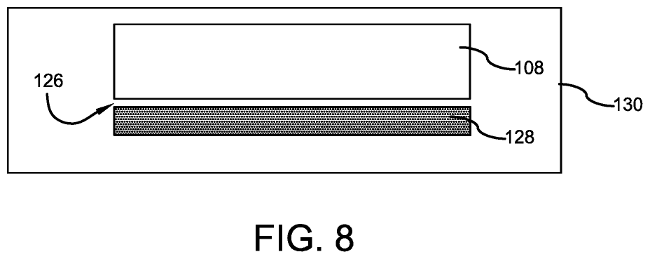

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an alert system that detects if a child is present in the backseat of the vehicle. There is also a long felt need in the art for an alert system that notifies a parent, driver, or caretaker when a child is present in the backseat but no one is present in the driver seat. Additionally, there is a long felt need in the art for a child safety system that prevents children from being left unattended in a vehicle, thereby reducing the risk of injuries or fatalities. Moreover, there is a long felt need in the art for a safety system that works on the detecting weight on the driver seat and the backseat for detecting an occupancy on the backseat. Further, there is a long felt need in the art for a system that provides a notification in a user device of a user upon detection of a child in the backseat. Finally, there is a long felt need in the art for a safety and alert system that offers parents, grandparents, and caregivers a quick and effective reminder that a child is still inside the vehicle when they are not present in the vehicle.

The present invention, in one exemplary embodiment, is a method for monitoring weight on a backseat of a vehicle. The method comprising the steps of activating a child safety alert beacon system to monitor the weight on the backseat and the driver seat of the vehicle, continuously monitoring the weight on the backseat and the driver seat using the backseat sensor and the driver seat sensor, respectively, determining if the backseat weight exceeds a predetermined threshold weight and if the driver seat weight is zero, transmitting an electric signal to a central controller if both conditions are met, activating a timer by the central controller, waiting by the controller for a predetermined amount of time to elapse, determining if the predetermined time has elapsed and if the backseat weight is still above the threshold weight and if the driver seat weight is still zero, generating an alert by the central controller if the conditions are met, to notify the driver or other user in the vehicle.

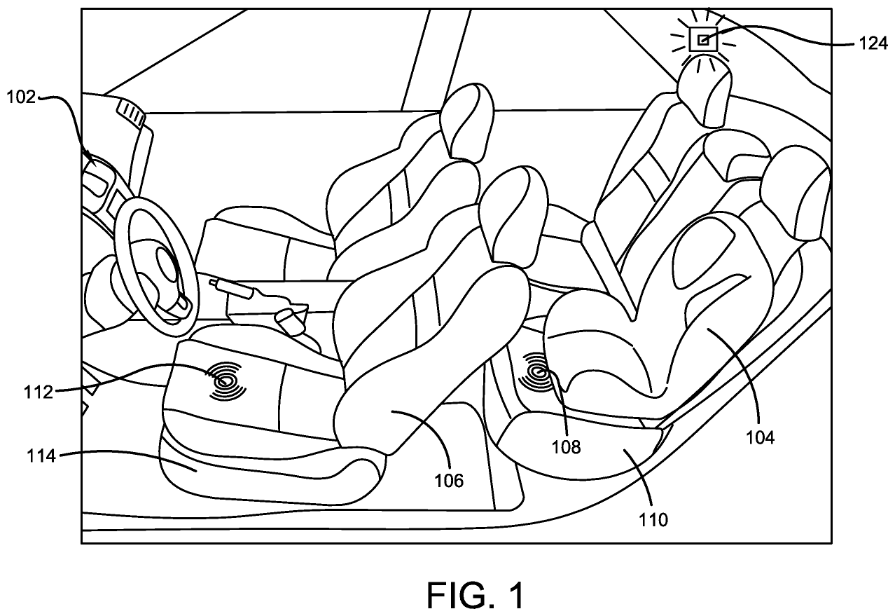

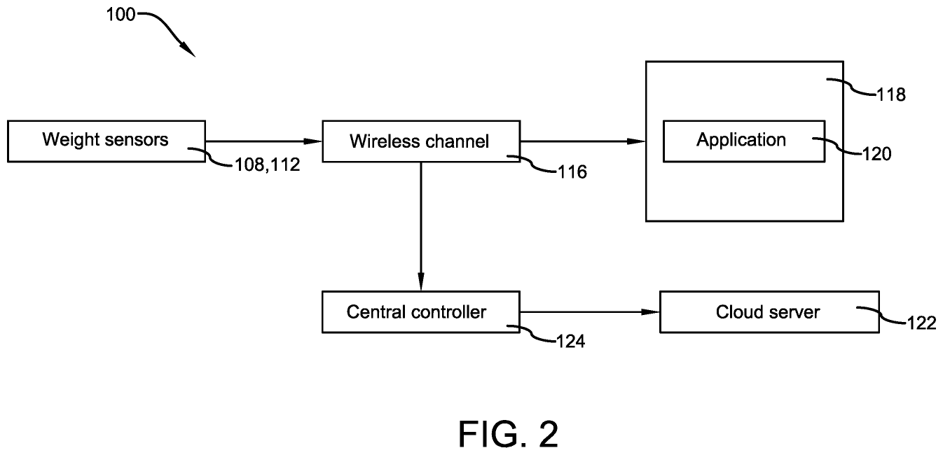

Referring initially to the drawings, FIG. 1 illustrates a side perspective view of a vehicle equipped with rear occupancy safety system of the present invention in accordance with the disclosed architecture. Referring to FIGS. 1 and 2, the rear occupancy safety system 100 of the present invention is designed to notify a driver or caretaker sitting in the vehicle 102 when weight on the backseat or child seat 104 is detected while weight on the driver seat 106 is not detected for a predetermined time period. More specifically, the system 100 includes at least one weight sensor 108 disposed in the base 110 of the backseat/child seat 104 and another weight sensor 112 disposed in the base 114 of the driver seat 106. The weight sensors 108, 112 can be integrated into the seats 104, 106 respectively during manufacturing of the vehicle 102 or can be retrofitted as an aftermarket system.

Each of the weight sensors 108, 112 is preferably a pressure sensor configured to measure the pressure exerted by the weight on the base of the respective seat. In another embodiment, one or both weight sensors can be a strain gauge sensor configured to measure the strain or deformation of the material of the seats 104, 106 when a weight is applied to it. The weight sensors 108, 112 are coupled to a central controller 124 disposed inside the vehicle 102 using a wireless communication network or channel 116. The wireless network 116 can be provided by the vehicle 102 or alternatively can be provided by a user device 118 coupled to the system 100 of the present invention. The wireless network 116 can be any conventional wireless channel, including, but not limiting to Bluetooth, Wi-Fi, Zigbee, Cellular Network and more.

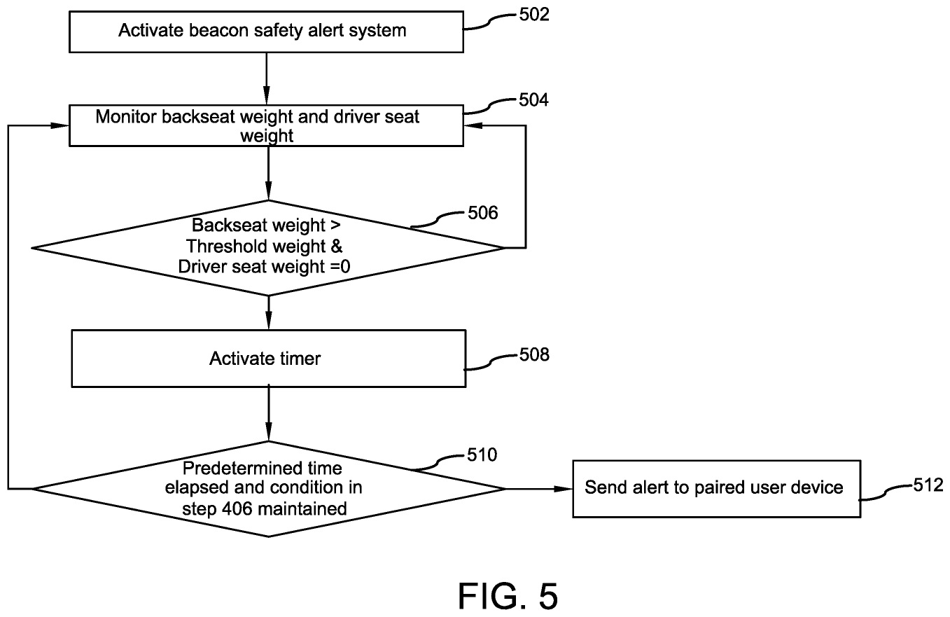

FIG. 2 illustrates a schematic view of the showing the rear occupancy safety system 100 showing the weight sensors and the supporting software application in accordance with the disclosed architecture. As illustrated, the sensors 108, 112 are paired to the central controller 124 which is connected wirelessly to the user device 118. The user device 118 can be any handheld computing device such as a smartphone and has an installed rear occupancy safety application 120. The application 120 is configured to provide notifications to a user when weight is detected by the backseat sensor 108 and simultaneously the weight is not detected by the driver seat sensor 112 for a predetermined time period as illustrated in FIG. 5.

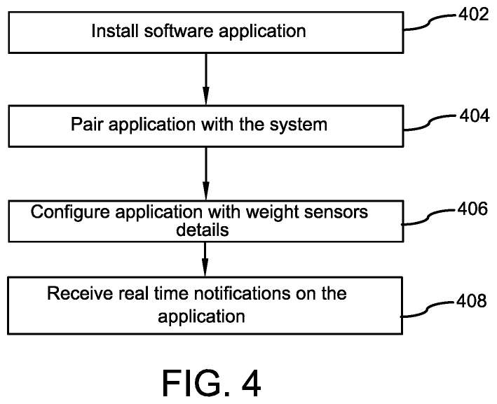

The application 120 is preconfigured with the pair of sensors 108, 112 as illustrated in FIG. 4 enabling the application 120 to receive sensor information from the central controller 124. The sensors 108, 112 provide the sensor information to the central controller 124 for processing and alert generation. It should be noted that the system 100 is designed to continuously monitor the weight on both the backseat/child seat 104 and the driver seat 106 continuously and provide information to the application 120. The system 100 also includes a cloud server 122 for storing emergency contact information that can be retrieved in case of an emergency when weight on the backseat 104 is detected for at least a higher threshold time while the weight is not detected on the driver seat 106. In some embodiments, a local server can also be used by the system 100 for storing emergency contact information.

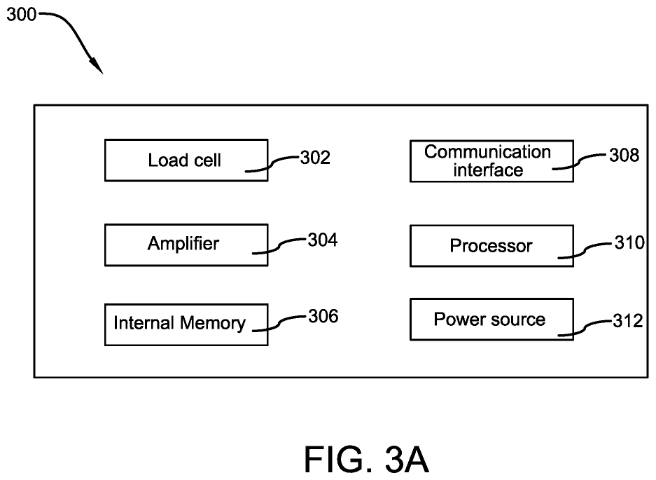

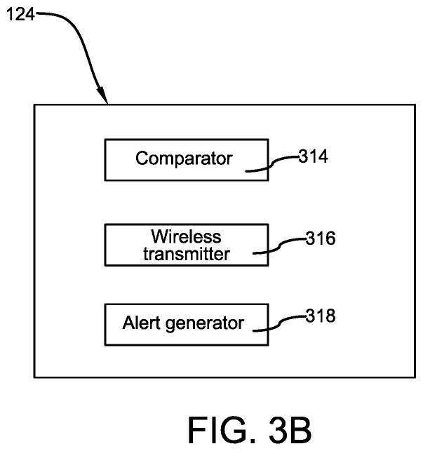

FIG. 3A illustrates a block diagram depicting essential structural components or modules disposed in a weight sensor used in the safety system of the present invention in accordance with the disclosed architecture. The weight sensor 300 (referred to any of the weight sensor 108, 112 of FIG. 1) includes a load cell 302 which is a sensor configured to convert weight into an electrical signal. The load cell 302 changes the electrical resistance thereof when weight is applied on the weight sensor 300 to produce an electrical output signal proportional to the applied force. An amplifier 304 is used for amplifying the electrical output signal of the load cell 302 for further processing. The signal from the load cell 302 is low and is required to be amplified using the amplifier 304.

An internal memory 306 is included for storing calibration data and configuration settings. The configuration such as threshold weight can be configured using the application 120 and is stored in the internal memory 306. The memory 306 can be one of non-volatile memory, flash memory, random access memory or any type read only memory. A communication interface 308 is used for establishing the wireless connection 116 with the central controller 124. The communication interface 308 is in the form of a chip that provides one or more of Bluetooth, Wi-Fi, Zigbee, Cellular network and more. The choice of communication interface 308 can depend on the specific requirements of the weight sensor 300, such as the range of communication required, the power consumption of the interface 300, and the data rate required.

A processor 310 controls the operation of the weight sensor 300 and processes the output from the amplifier 304. The processor 310 is also preconfigured with a threshold weight for eliminating false positives for transmitting a notification. The processor 310 can be any of a microcontroller, a digital signal processor (DSP), a field-programmable gate array (FPGA) and the like. For providing electric power to the weight sensor 300, a power source 312 in the form of a battery is integrated in the sensor 300. The power source 312 can be rechargeable or disposable and in some embodiments, can use solar power for recharging.

FIG. 3B illustrates essential components of the central controller 124 for facilitating determination and transmission of alert for safety in accordance with the disclosed architecture. The controller 124 has a comparator 314 for comparing sensor information received from the backseat sensor 108 and the driver seat sensor 112. The comparator 314 is configured to give the difference between the weight detected by the sensors 108, 112. A wireless transmitter 316 is configured to provide an alert to remote device and an alert generator 318 is configured to generate an alert inside the vehicle 102.

FIG. 4 illustrates a process of pairing the weight sensors 108, 112 used in the safety system of the present invention with a user device having an installed application in accordance with the disclosed architecture. Initially, software application 120 is installed in a user device of a driver of a vehicle (Step 402). The application 120 can be downloaded from playstore such as Google playstore, Appstore, and the like. Then, the application 120 is activated to pair with the system 100 (the central controller 124) using the channel established by the central controller (Step 404). Thereafter, the application 120 is configured with the details of weight sensors disposed in a vehicle (Step 406). The configuration can include minimum weight to be detected by the sensors, the time duration post which a notification or alert is to be generated and more. Post pairing, the application 120 is configured to receive real time notifications from the system installed in the vehicle that offers parents, grandparents, and caregivers a quick and effective reminder that a child is still inside the vehicle (Step 408).

FIG. 5 illustrates a flow diagram depicting a process of generating an alert for indicating a child left on a backseat of a vehicle by the child safety alert beacon system of the present invention in accordance with the disclosed architecture. Initially, the child safety alert beacon system is activated for monitoring the weight on the backseat and the driver seat of the vehicle (Step 502). In some embodiments of the present invention, the system 100 is automatically activated on ignition of the vehicle or alternatively in other embodiments, the system is manually activated by a user. Then, upon activation of the system 100, the backseat sensor 108 and the driver seat sensor 112 start to continuously monitor the weight on the backseat and the driver seat respectively (Step 504).

In the next step 506, it is checked by the sensors if the backseat weight exceeds a predetermined threshold weight and if the driver seat weight is zero. In such cases, the transmission is sent to the central controller 124. If both conditions in step 506 are met, then, the central controller 124 activates the timer while monitoring the condition of step 506 (Step 508). Then, the central controller 124 continues to wait for a predetermined amount of time to elapse. The duration may be set according to specific requirements or regulations, such as local laws or safety standards. In step 510, it is determined if the predetermined time has elapsed and if the backseat weight is still above the threshold weight and if the driver seat weight is still zero. In case, the conditions are met in step 510, then, an alert is generated by the central controller 124 to notify the driver or other user. The alert may be in the form of an audible alarm, visual display, or other suitable means.

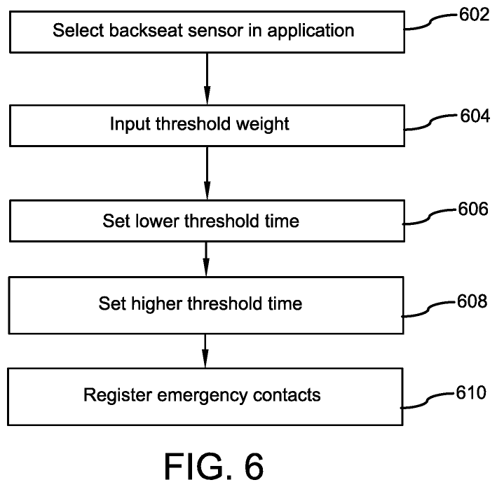

FIG. 6 illustrates a flow diagram depicting a process of configuring the backseat sensor of the child safety system of the present invention using the software application in accordance with the disclosed architecture. Initially, the backseat sensor is selected in the software application 120 (Step 602). The application 120 can be paired to multiple sensors and one or more sensors using the displayed sensor ID can be selected in the application. Then, a threshold weight is input by a user for the backseat sensor wherein the backseat sensor senses the weight above the threshold weight for alert generation as described in step 506 of FIG. 1 (Step 604).

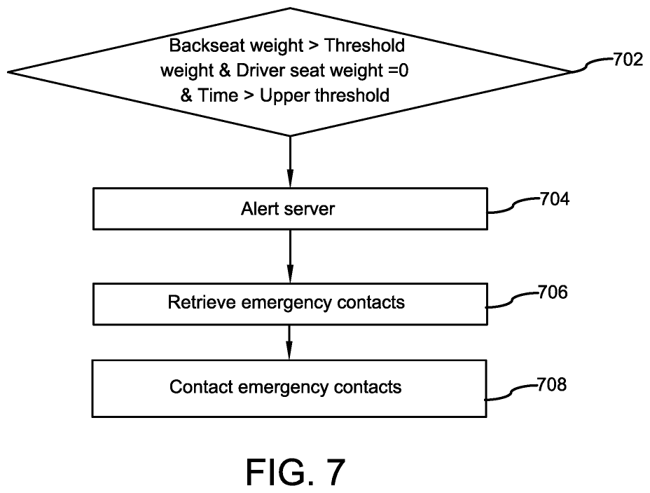

Thereafter, the user sets a lower threshold time (Step 606) which is used by the system for generating an alert to the driver as described in FIG. 5. An upper threshold time is set by the user for the backseat sensor (Step 608) wherein the upper threshold time is used for alerting one or more emergency contacts as described in FIG. 7. The user can register emergency contacts in the system 100 using the application (Step 610) wherein the emergency contacts are also stored in the cloud server 122 as illustrated in FIG. 2.

It should be noted that same process can be implemented for configuration of the driver seat sensor for configuring similar parameters for efficient working of the safety system 100.

FIG. 7 illustrates a flow chart depicting a process of alerting emergency contacts when the backseat sensor continues to detect weight while driver seat sensor detects zero weight in accordance with the disclosed architecture. It is determined by the system if the backseat sensor detects a weight which is greater than a threshold weight and the driver seat weight is detected at zero weight and a predetermined time has lapsed which is greater than the upper threshold defined for the backseat sensor as illustrated in FIG. 6 (Step 702). If the result is positive, then the cloud server 122 is alerted by the system 100 (Step 704) and configured emergency contacts are retrieved from the server for contact (Step 706). Finally, one or more emergency contacts are contacted and/or alerted by the server (Step 708).

In one embodiment of the present invention, a priority is given to the emergency contacts for communication based on the proximity of the location of the emergency contacts with the location of the vehicle in which the system 100 is installed. This leads to quick and effective help for the children inside the vehicle.

In one embodiment of the present invention, the sensors 108, 112 can be positioned on the bases 110, 114 respectively using an adhesive layer 128 which is positioned on the bottom layer 126 of each sensor. Each sensor can be covered in a weatherproof and durable closure 130 for prevention from weather elements and physical damage.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “rear occupancy safety system”, “safety system”, “alert system”, “child safety alert beacon system”, and “system” are interchangeable and refer to the child safety and alert system 100 of the present invention.

Notwithstanding the forgoing, the child safety and alert system 100 of the present invention can be of any suitable size and configuration as is known in the art without affecting the overall concept of the invention, provided that it accomplishes the above stated objectives. One of ordinary skill in the art will appreciate that the child safety and alert system 100 as shown in the FIGS. are for illustrative purposes only, and that many other sizes and shapes of the child safety and alert system 100 are well within the scope of the present disclosure. Although the dimensions of the child safety and alert system 100 are important design parameters for user convenience, the child safety and alert system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rear occupancy safety and notification system comprising:
a first weight sensor disposed in a base of a backseat and a second weight sensor disposed in a base of a driver seat;
wherein said first weight sensor is integrated into said backseat and said second weight sensor is integrated into said driver seat;
wherein said first sensor is a pressure sensor for detecting a first weight exerted on said base of said backseat;
wherein said second sensor is a pressure sensor for detecting a second weight exerted on said base of said driver seat;
a user handheld computing device having an occupancy safety application for receiving a notification to the user; and
further wherein said notification is based on said first sensor detecting said first weight is above a first predetermined weight and said second sensor detecting said second weight is below a predetermined weight.

2. The rear occupancy safety and notification system of claim 1, wherein said first sensor is a strain gauge sensor for measuring a deformation of material of said backseat when said first weight is applied to said backseat.

3. The rear occupancy safety and notification system of claim 2, wherein said second sensor is a strain gauge sensor for measuring a deformation of material of said driver seat when said second weight is applied to said driver seat.

4. The rear occupancy safety and notification system of claim 3 further comprising a central controller inside a vehicle coupled to said first sensor and said second sensor with a wireless communication channel.

5. The rear occupancy safety and notification system of claim 4, wherein said first sensor detecting and said second sensor detecting is for a predetermined period of time.

6. The rear occupancy safety and notification system of claim 5, wherein said notification is an alert after said predetermined period of time has elapsed.

7. The rear occupancy safety and notification system of claim 5, wherein said first sensor detecting and said second sensor detecting is continuous.

8. The rear occupancy safety and notification system of claim 6, wherein said backseat is a child seat.

9. The rear occupancy safety and notification system of claim 1, wherein said first sensor having a first load cell to convert said first weight into a first electrical signal.

10. The rear occupancy safety and notification system of claim 9, wherein said second sensor having a second load cell to convert said second weight into a second electrical signal.

11. A rear occupancy safety and notification system comprising:
a first weight sensor disposed in a base of a backseat and a second weight sensor disposed in a base of a driver seat;
wherein said first weight sensor is integrated into said backseat and said second weight sensor is integrated into said driver seat;
wherein said first sensor is a pressure sensor for detecting a first weight exerted on said base of said backseat;
wherein said second sensor is a pressure sensor for detecting a second weight exerted on said base of said driver seat;
a user handheld computing device having an occupancy safety application for receiving a notification to the user;
a comparator for comparing said first weight received from said first sensor to a first threshold weight and for comparing said second weight received from said second sensor to a second threshold weight; and
further wherein said notification is based on said first sensor detecting said first weight is above said first threshold weight and said second sensor detecting said second weight is below said second threshold weight.

12. The rear occupancy safety and notification system of claim 11, wherein said first sensor is a strain gauge sensor for measuring a deformation of material of said backseat when said first weight is applied to said backseat.

13. The rear occupancy safety and notification system of claim 12, wherein said second sensor is a strain gauge sensor for measuring a deformation of material of said driver seat when said second weight is applied to said driver seat.

14. The rear occupancy safety and notification system of claim 11 further comprising a central controller inside a vehicle coupled to said first sensor and said second sensor with a wireless communication channel.

15. The rear occupancy safety and notification system of claim 11, wherein said first sensor detecting and said second sensor detecting is for a predetermined period of time.

16. The rear occupancy safety and notification system of claim 11, wherein said notification is an alert after said predetermined period of time has elapsed.

17. The rear occupancy safety and notification system of claim 11, wherein said backseat is a child seat.

18. A method of detecting a rear occupant in a vehicle, the method comprising the steps of:
providing a first weight sensor disposed in a base of a backseat and a second weight sensor disposed in a base of a driver seat;
integrating said first weight sensor into said backseat and integrating said second weight sensor into said driver seat, wherein said first sensor is a pressure sensor;
detecting a first weight exerted on said base of said backseat, wherein said second sensor is a pressure sensor;
detecting a second weight exerted on said base of said driver seat;
installing an occupancy safety application onto a user handheld computing device for receiving a notification to a user;
comparing said first weight received from said first sensor to a first threshold weight;
comparing said second weight received from said second sensor to a second threshold weight; and
sending said notification based on said first sensor detecting said first weight is above said first threshold weight and said second sensor detecting said second weight is below said second threshold weight.

19. The method of detecting a rear occupant of a vehicle of claim 18, wherein said first sensor detecting and said second sensor detecting is for a predetermined period of time.

20. The method of detecting a rear occupant of a vehicle of claim 19, wherein said notification is an alert after said predetermined period of time has elapsed.
